(19) United States
(12) Patent Application Publication
(10) Pub. No.: US 2006/0026427 A1
(43) Pub. Date: Feb. 2, 2006

(54) Method and system for entity authentication using an untrusted device and a trusted device

(76) Inventor: Stanley T. Jefferson, Palo Alto, CA (US)

Correspondence Address: AGILENT TECHNOLOGIES, INC.;Legal Department, DL 429, Intellectual Property Administration, P.O. Box 7599, Loveland, CO, 80537-0599, US

(21) Appl. No.: 10/909,030

(22) Filed: Jul. 30, 2004

(51) Int. Cl. H04L 9/00; H04K 1/00

(52) U.S. Cl. 713/170; 713/186

(57) ABSTRACT

A trusted device obtains entity data from an entity. The entity data are transmitted to an untrusted device, and the untrusted device generates a summary of the entity data. The summary includes information to identify or recognize one or more elements or properties associated with the entity data. The summary is transmitted to the trusted device and assists the trusted device in performing an independent authentication of the identity of the entity.

### BACKGROUND

The increased use of electronic data in both personal and business transactions has led to a growing concern regarding the security of electronic data. Valuable private data or transactions, such as financial data, may be compromised by the theft or unauthorized use of a device, such as a computer or personal digital assistant. In an attempt to avoid the unauthorized use of a device, some systems require a password, user identification, or personal identification number (PIN) to be entered before access to the system or device is provided. But individuals may not properly secure or maintain the security of passwords, user identifications, and PINs.

Entity authentication provides increased security by providing access to data, systems, or areas only after an individual or entity has been identified by one or more physical or behavioral attributes. Fingerprint scanning, voice recognition, and facial thermograms are examples of biometric data that may be used to authenticate the identity of an individual.

Devices that capture biometric data and authenticate the identity of an individual are typically self-contained devices that perform both functions. The devices can therefore be expensive, since a sufficient amount of computation power and memory are needed to perform both functions. Furthermore, some biometric devices are difficult to use because an individual or relevant body part (e.g. an eye or hand) must be positioned properly before the biometric data can be captured.

### SUMMARY

In accordance with the invention, a method and system for entity authentication using an untrusted device and a trusted device are provided. A trusted device obtains entity data from an entity. The entity data are transmitted to an untrusted device, and the untrusted device generates a summary of the entity data. The summary includes information to identify or recognize one or more elements or properties associated with the entity data. The summary is transmitted to the trusted device and assists the trusted device in performing an independent authentication of the identity of the entity.

### BRIEF DESCRIPTION OF THE DRAWINGS

The invention will best be understood by reference to the following detailed description of embodiments in accordance with the invention when read in conjunction with the accompanying drawings, wherein:

FIG. 1 is a block diagram of a system for entity authentication in accordance with an embodiment of the invention;

FIG. 2 is a block diagram of one embodiment of a portion of an untrusted device in accordance with FIG. 1;

FIG. 3 is a block diagram of one embodiment of a portion of a trusted device in accordance with FIG. 1;

FIG. 4 illustrates a flowchart of a first method for entity authentication in accordance with an embodiment of the invention; and

FIGS. 5A-5B depict a flowchart of a second method for entity authentication in accordance with an embodiment of the invention.

### DETAILED DESCRIPTION

The invention relates to a method and system for entity authentication using an untrusted device and a trusted device. The following description is presented to enable one skilled in the art to make and use embodiments of the invention, and is provided in the context of a patent application and its requirements. Various modifications to the disclosed embodiments will be readily apparent to those skilled in the art, and the generic principles herein may be applied to other embodiments. Thus, the invention is not intended to be limited to the embodiments shown, but is to be accorded the widest scope consistent with the appended claims and with the principles and features described herein.

The invention is described herein with reference to a method for authenticating the identity of a person using biometric data. Other embodiments in accordance with the invention are not limited to this implementation. Embodiments in accordance with the invention may be used to authenticate any entity, such as a person, animal, or property. For example, in some embodiments in accordance with the invention, livestock may be identified and tracked or money determined to be counterfeit or legitimate.

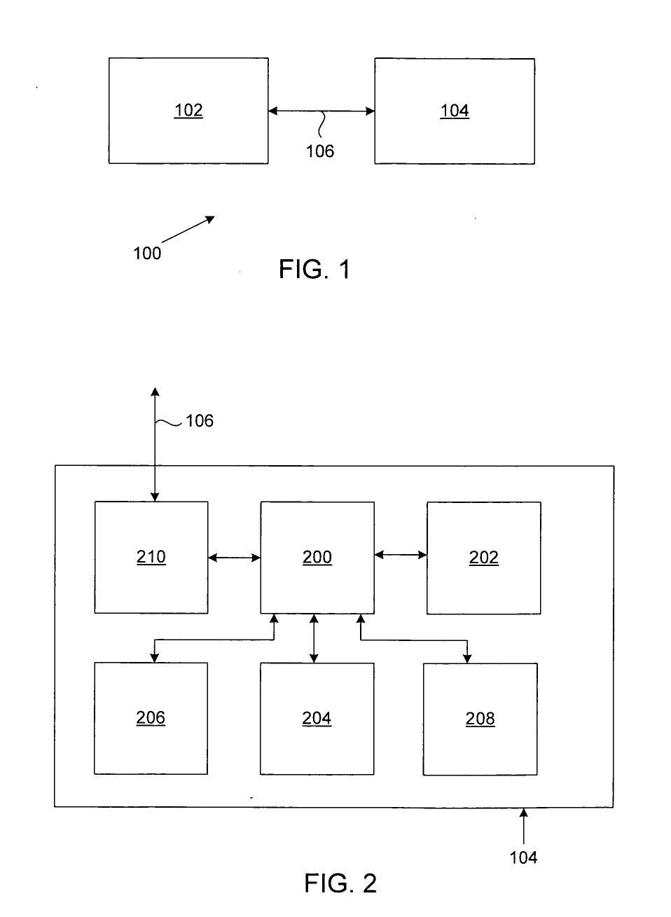

With reference to the figures and in particular with reference to FIG. 1, there is shown a block diagram of a system for entity authentication in accordance with an embodiment of the invention. System 100 includes a trusted device 102 and an untrusted device 104. Communication path 106 transmits data between the two devices. Trusted device 102 and untrusted device 104 are situated together in the FIG. 1 embodiment, so communication path 106 is configured as a single secure or unsecured, wired or wireless, network connection. In other embodiments in accordance with the invention, trusted device 102 and untrusted device 104 may be located in different locations, and as such, communication path 106 may include one or more wired or wireless network connections.

Device 102 is known as a “trusted” device because one or more security features prevent modification of the data, hardware, software and firmware in device 102. For example, one security feature zeros the memory in trusted device 102 whenever a person or apparatus attempts to modify a hardware, firmware, or software component within device 102. Trusted device 102 may also include other types of security features, such as electronic shielding and tamper evidence and tamper response.

In this embodiment in accordance with the invention, trusted device 102 is implemented as a device for obtaining biometric data. For example, trusted device 102 may be implemented as an iris, fingerprint, or retinal scanner, a voice, hand vein, or handwriting recognition device, a hand geometry device, or a facial thermogram device. In other embodiments in accordance with the invention, trusted device 102 may be implemented as any device that captures entity data.

Device 104 is known as an “untrusted” device because the security features in device 104 are limited or non-existent. In this embodiment in accordance with the invention, untrusted device 104 is implemented as a computation device, examples of which include a computer and a personal digital assistant. In the FIG. 1 embodiment, untrusted device 104 supplies more computational power and memory for entity authentication than trusted device 102.

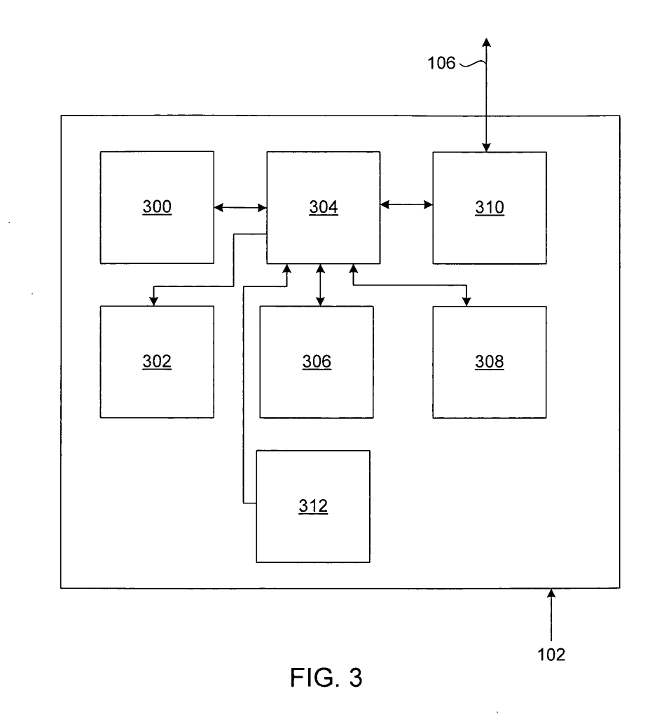

FIG. 2 is a block diagram of one embodiment of a portion of an untrusted device in accordance with FIG. 1. Untrusted device 104 includes a processor 200, volatile memory 202, non-volatile memory 204, biometric authentication software application 206, input and output devices 208, and communications interface 210. Communications interface 210 is implemented as a universal serial bus (USB) interface in this embodiment in accordance with the invention. Communications interface 210 may be implemented differently in other embodiments in accordance with the invention. For example, communications interface 210 may be configured as an IEEE 1394 interface.

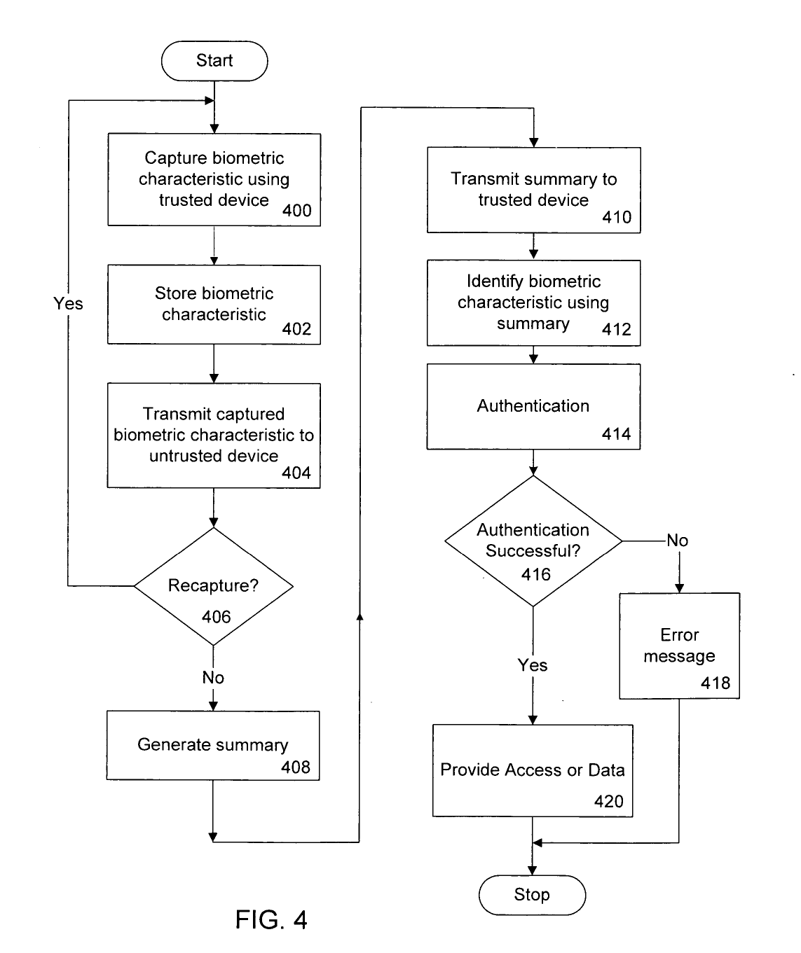

FIG. 3 is a block diagram of one embodiment of a portion of a trusted device in accordance with FIG. 1. Trusted device 102 is implemented as an iris scanner in this embodiment. Trusted device 102 may be implemented as any device that captures entity data in other embodiments in accordance with the invention. For example, trusted device 102 may be implemented as a fingerprint scanner or a voice recognition device.

Trusted device 102 includes imaging sensor 300, display 302, processor 304, volatile memory 306, non-volatile memory 308, communications interface 310, and one or more input devices 312. The image of an iris is captured by image sensor 300 and may be displayed on display 302. The image is transmitted to untrusted device 104 using communications interface 310. In this embodiment, input devices 312 are used to control trusted device 102. Examples of input devices 312 include an on-off button and an image capture button.

Non-volatile memory 308 stores firmware, software, and verification iris data for a person in this embodiment. Verification data may be configured, for example, as a reference image of an iris, a processed iris code, or an iris template. Non-volatile memory 308 also stores private information for one or more individuals, such as a private key for cryptography uses. The cryptography uses include encryption and the creation of digital signatures. The private information may be generated and stored by the manufacturer of the trusted device or by the user.

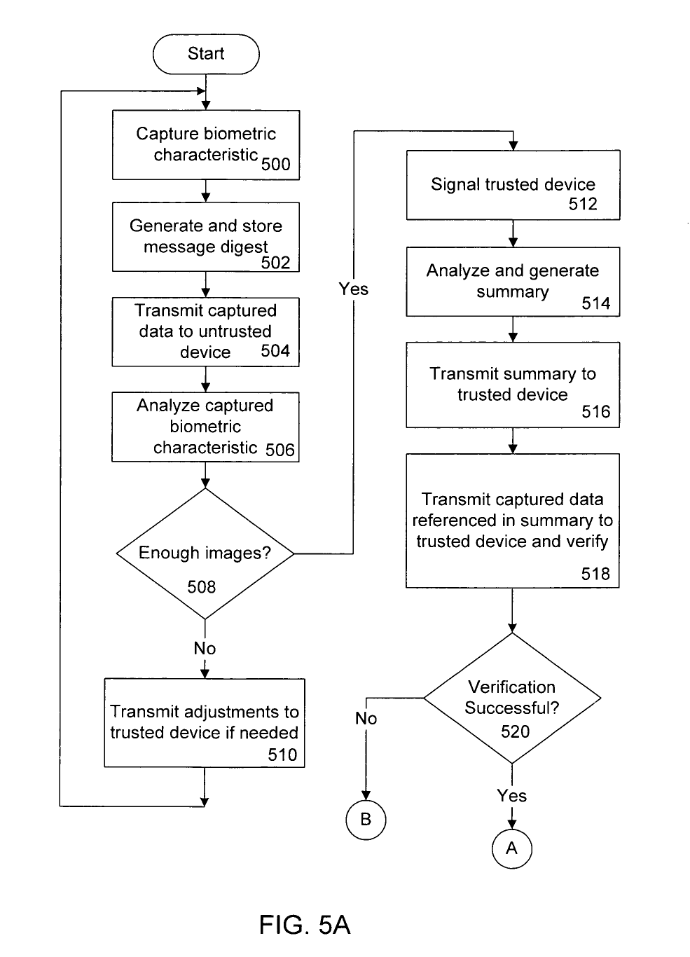

Referring now to FIG. 4, there is shown a flowchart of a first method for entity authentication in accordance with an embodiment of the invention. In this embodiment, the entity data includes an image of an iris and the trusted device obtains the image of the iris by scanning a person's eye or face. Initially a trusted device captures an image of the person's eye or face, as shown in block 400. The image is then stored in the trusted device (block 402). A copy of the image is also transmitted to the untrusted device, as shown in block 404.

A determination is then made at block 406 as to whether the image of the eye or face needs to be re-captured. For example, in one embodiment in accordance with the invention, the untrusted device analyzes the properties of the image. When one or more properties of the image are unacceptable, the process returns to block 400 and repeats through blocks 400-406 until the image is acceptable.

If an image is not recaptured, the untrusted device generates a summary of the image at block 408. For example, in this embodiment in accordance with the invention, the untrusted device performs a number of computations that provide directions or assertions on how to identify or recognize the iris within the image. One technique for iris recognition and authentication is disclosed in “How Iris Recognition Works” by John Daugman (IEEE Transactions On Circuits And Systems For Video Technology, Vol. 14, No. 1, January 2004, pp. 21-30). The technique includes the following steps:

1. Scrub specular reflections

2. Localize the eye and iris

3. Fit papillary boundary

4. Detect and fit both eyelids

5. Remove lashes and contact lens edges

6. Demodulation and iris code creation

7. Perform exclusive-or comparison of two iris codes

Directions or assertions for steps one through five are included in the summary in this embodiment in accordance with the invention. For example, in the above-identified iris recognition technique the eyelids are fitted with splines, which can be specified by a finite set of coordinates. The last two steps are performed in conjunction with block 414.

Embodiments in accordance with the invention, however, are not limited to authentication by iris scanning. Different types of entity data may be used to authenticate the identity of a person, animal, or property in other embodiments in accordance with the invention. Therefore, the amount and type of information included in a summary will vary depending on the entity data used to identify an entity.

Next, at blocks 410 and 412, respectively, the untrusted device transmits the summary to the trusted device and the trusted device identifies the iris using the summary and the image stored at block 404. The trusted device then independently authenticates the identity of the person using the recognized iris and the verification data pre-stored in the trusted device.

As described in conjunction with FIG. 3, the verification data may include, for example, a reference image of an iris, a processed iris code, or an iris template. In this embodiment in accordance with the invention, the trusted device authenticates the identity of the person by creating an iris code using the iris recognized from the image and then comparing the created iris code with a pre-stored iris code (steps six and seven above).

A determination is then made at block 416 as to whether the authentication is successful. If not, an error message is generated at block 418 and the process ends. If the created iris code matches to a desired level of certainty the pre-stored iris code and authentication is successful, the process continues at block 420 where access or data is made available. How closely the created iris code matches the pre-stored iris code is determined by the application and the desired level of security. In some embodiments, a near perfect match is required, while in other embodiments a less than perfect match is acceptable.

When the identity of the person has been authenticated, the person may be given access to a system, building, area, or data, or data may be used for computational applications such as cryptography. For example, the trusted device may use the pre-stored private key associated with the person and generate a digitally signed document using the private key. The document may be displayed, for example, on display 302 (FIG. 3). The digitally signed document may be used to execute an electronic contract or complete an electronic purchase order.

Other embodiments in accordance with the invention may perform only some of the blocks of FIG. 4, or the embodiments may include additional or different blocks in a method for entity authentication. For example, in another embodiment in accordance with the invention, a trusted device captures only a single image of the person's eye or face and this one image is used to authenticate the person. Block 406 is not used in these embodiments, and the process passes directly from block 404 to block 408. And in other embodiments in accordance with the invention, the image may be recaptured because the system is creating a compilation image or a super resolution reconstructed image. A compilation image is created by stitching sections of two or more images together to form a single composite image. A super resolution reconstructed image is a high-resolution image constructed from a set of low-resolution images.

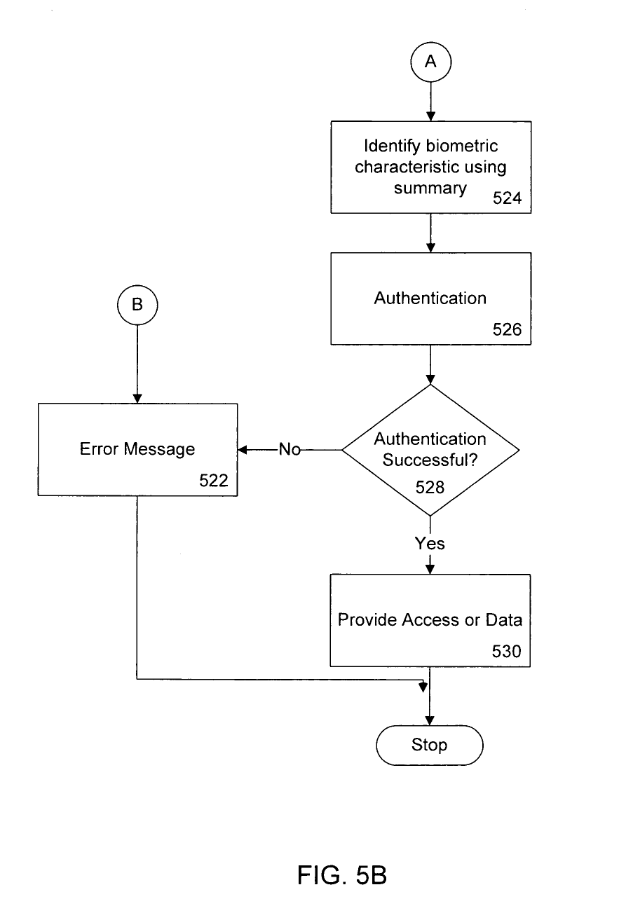

FIGS. 5A-5B depict a flowchart of a second method for entity authentication in accordance with an embodiment of the invention. Like the embodiment of FIG. 4, the biometric data is an iris and the trusted device obtains an image of the iris by scanning the person's eye or face. The process begins with the trusted device capturing an image of the person's eye or face, as shown in block 500.

Next, at block 502, the trusted device generates a message digest for the image and stores the message digest in memory. The message digest may be generated, for example, by performing a one-way hash function, such as, for example, MD5, on the captured image. The captured image is then transmitted to the untrusted device and analyzed by the untrusted device, as shown in blocks 504 and 506, respectively.

A determination is then made at block 508 as to whether a desired number of images have been captured by the trusted device. For example, the untrusted device may determine whether an image of the iris is in focus and depicts the user's iris in sufficient detail. If the image is out of focus or contains insufficient data, the untrusted device transmits adjustment information to the trusted device, as shown in block 510. In response to receiving the adjustment information, the trusted device may adjust one or more parameters associated with the imager or the person may need to reposition their face for a better view of the eye. The process then returns to block 500.

When a desired number of images have been captured (block 508), the process passes to block 512 where the untrusted device signals the trusted device to stop capturing images. The untrusted device then analyzes the captured image or images and generates a summary at block 514. For example, the untrusted device may sort through and analyze multiple images to obtain the single best image for authentication purposes. The summary is then transmitted to the trusted device (block 516). The untrusted device also transmits the image used to generate the summary, as shown in block 518.

In this embodiment in accordance with the invention, the trusted device verifies the image supplied by the untrusted device matches the image captured by the trusted device at block 500. The trusted device generates a message digest for the returned image and compares that message digest with the message digest generated at block 502. If the two message digests match, the image is verified. As part of the verification process, the trusted device may require the image be captured prior to the expiration of a predetermined time period. For example, the trusted device may require the image of the iris be captured within the last thirty to ninety seconds.

A determination is then made at block 520 as to whether verification of the image is successful. If not, the process passes to block 522, where an error message is generated and the process ends. If, however, verification is successful, the process continues at block 524 where the trusted device accesses the verification data pre-stored in the trusted device. The trusted device then authenticates the identity of the person at block 526. To authenticate the identity of the person, the trusted device uses the summary to recognize the iris in the image associated with the summary. The trusted device then authenticates the identity of the person using the recognized iris and the verification data pre-stored in the trusted device.

Next, at block 528, a determination is made as to whether the authentication is successful. If not, an error message is generated at block 522 and the process ends. If authentication is successful, the process continues at block 530 where access or data is made available.

The blocks depicted in FIGS. 5A-5B may be performed in a different order in other embodiments in accordance with the invention. Furthermore, other embodiments in accordance with the invention may perform only some of the blocks of FIGS. 5A-5B, or the embodiments may include additional or different blocks in a method for entity authentication. For example, in another embodiment in accordance with the invention, a trusted device captures multiple images of a person's eye or face to create a compilation image or a super resolution reconstructed image. A message digest is generated for each captured image and the images transmitted to the untrusted device. The untrusted device then generates a summary using the multiple images. The summary includes directions or assertions on how to construct the compilation or super resolution image. The images or image identifiers are returned to the trusted device along with the summary. In some embodiments in accordance with the invention, the images may be returned to the trusted device one at a time and used to incrementally construct the compilation or super resolution image. The trusted device then generates the compilation or super resolution image using the summary and authenticates the entity with the compilation or super resolution image and corresponding verification data.

1. A system for entity authentication, comprising:
a first device capturing entity data from an entity; and
a second device receiving the entity data and in response thereto providing a summary of the entity data to the first device, wherein the first device uses the summary to authenticate the entity.

2. The system of claim 1, wherein the summary comprises one or more assertions that assist the first device in identifying one or more properties associated with the entity data.

3. The system of claim 1, wherein the summary comprises one or more assertions that allow the first device to construct entity data associated with the summary.

4. The system of claim 1, wherein the first device stores verification data associated with the entity.

5. The system of claim 4, wherein the first device authenticates the entity using the summary, captured entity data, and the verification data.

6. A method for biometric authentication, comprising:
generating a summary of captured entity data, wherein the summary includes information to identify one or more properties associated with the entity data;
transmitting the summary; and
authenticating an entity using the summary.

7. The method of claim 6, further comprising transmitting the entity data with the summary.

8. The method of claim 7, wherein authenticating the entity comprises:
identifying the one or more properties using the entity data transmitted with the summary;
accessing pre-stored verification data; and
comparing the one or more properties with the pre-stored verification data.

9. The method of claim 6, further comprising capturing entity data from an entity.

10. The method of claim 6, further comprising generating a message digest for the captured entity data.

11. The method of claim 10, further comprising analyzing a condition of the captured entity data.

12. The method of claim 11, further comprising providing adjustment information to a device capturing the entity data based on the analysis of the condition of the captured entity data.

13. The method of claim 9, wherein capturing entity data from an entity comprises capturing a plurality of entity data from an entity.

14. The method of claim 13, further comprising reviewing the plurality of captured entity data to determine one or more captured entity data suitable for authentication prior to generating the summary.
